(19) United States
(12) Patent Application Publication
(10) Pub. No.: US 2014/0379652 A1
(43) Pub. Date: Dec. 25, 2014

(54) METHOD, SYSTEM AND COMPUTER PRODUCT PROGRAM FOR GOVERNANCE OF DATA MIGRATION PROCESS

(71) Applicant: Infosys Limited, Bangalore (IN)

(72) Inventors: Gopi Krishna Balasa, Hyderabad (IN); Radha Krishna Pisipati, Hyderabad (IN)

(73) Assignee: INFOSYS LIMITED, Bangalore (IN)

(21) Appl. No.: 14/220,018

(22) Filed: Mar. 19, 2014

(30) Foreign Application Priority Data
Jun. 24, 2013 (IN) 2722/CHE/2013

(51) Int. Cl. G06F 17/30

(52) U.S. Cl. CPC G06F 17/30575
USPC 707/634

(57) ABSTRACT

Embodiments include a method, system and computer product program for governance of data migration process in an enterprise from at least one source to at least one target. The method includes receiving, using a rules engine, the source information and the target information in response to a request for the data migration. The method also includes, identifying, using the rules engine, at least one business rule governing the data migration process based on the received source information and the target information. The method further includes instructing to initiate the data migration process by migration engine based on the identified business rule.

### FIELD

The field generally relates to large data governance, and more particularly, to a method and system for governance of data migration process while carrying out large data migration.

### BACKGROUND

Generally, various data migration tools and extract, transform, load (ETL) tools are used for migration of large data in enterprises. Existing Data migration tools include SQL Migration Assistant software and Oracle Migration Workbench software. ETL tools such as Informatica software, IBM Information Server software, and Microsoft SSIS software are also useful for data migrations. The existing technologies do not have any Information Governance models while they move the data between different kinds of systems. The purpose of the data movement is fully ignored and therefore it is fully dependent on a developer's expertise, underlined architecture and on the designed data flows, which will decide the success or failure of the data migration deployment. However, in these tools, there are no specific governance mechanisms of data migration process, which are essential for successful large data migrations. In addition, the existing tools or approaches do not provide migration facility across various packages such as SAP, PeopleSoft and Oracle applications.

Hence, there is a need of a method and system and computer product program for governance of data migration process in an enterprise for large data to address the aforementioned issues.

### SUMMARY

An object of the invention is to provide a method, system and computer product program for governance of large data migration in an enterprise.

Another object of the invention is to provide re-usable enterprise rules repository for governance of large data migration.

Yet another object of the invention is to eliminate or reduce the person dependency, skills set expertise required for functional and technical aspects for large data migration.

To achieve the objectives mentioned above, the invention in one embodiment provides a method for governance of data migration process in an enterprise from at least one source to at least one target is provided. The method includes receiving source information and target information using a rules engine in response to the request for data migration. The method also includes identifying using the rules engine at least one business rule governing the data migration process based on the received source information and the target information. The method further includes instructing to initiate the data migration process by migration engine based on the identified business rule.

In another embodiment, a system for governance of data migration process in an enterprise from at least one source to at least one target is provided. The system includes an enterprise rules repository to store and provide at least one business rule. The system also includes a rules engine adapted to identify at least one of the business rule governing the data migration process based on the source information and the target information. The system further includes a migration engine adapted to initiate the data migration process in accordance to the identified business rule.

In yet another embodiment, a computer program product for use with a computer, for governance of data migration process in an enterprise from at least one source to at least one target is provided. The computer program product includes the instructions to perform the steps of receiving the source and the target information, in response to request for data migration. The computer program product also includes identifying at least one business rule governing the data migration process, by the rules engine based on the received source information and the target information. The computer program product further includes initiating the data migration, by the data migration engine based on the identified business rules.

### BRIEF DESCRIPTION OF DRAWINGS

The accompanying drawings, which constitute a part of this disclosure, illustrate various embodiments and aspects of present invention and together with the description, explain the principle of the invention.

FIG. 1 is a flowchart representing steps involved in a method for governance of data migration process in accordance with an embodiment of the invention.

FIG. 2 is a diagrammatic representation of a system for governance of data migration process in accordance with an embodiment of the invention.

### DETAILED DESCRIPTION

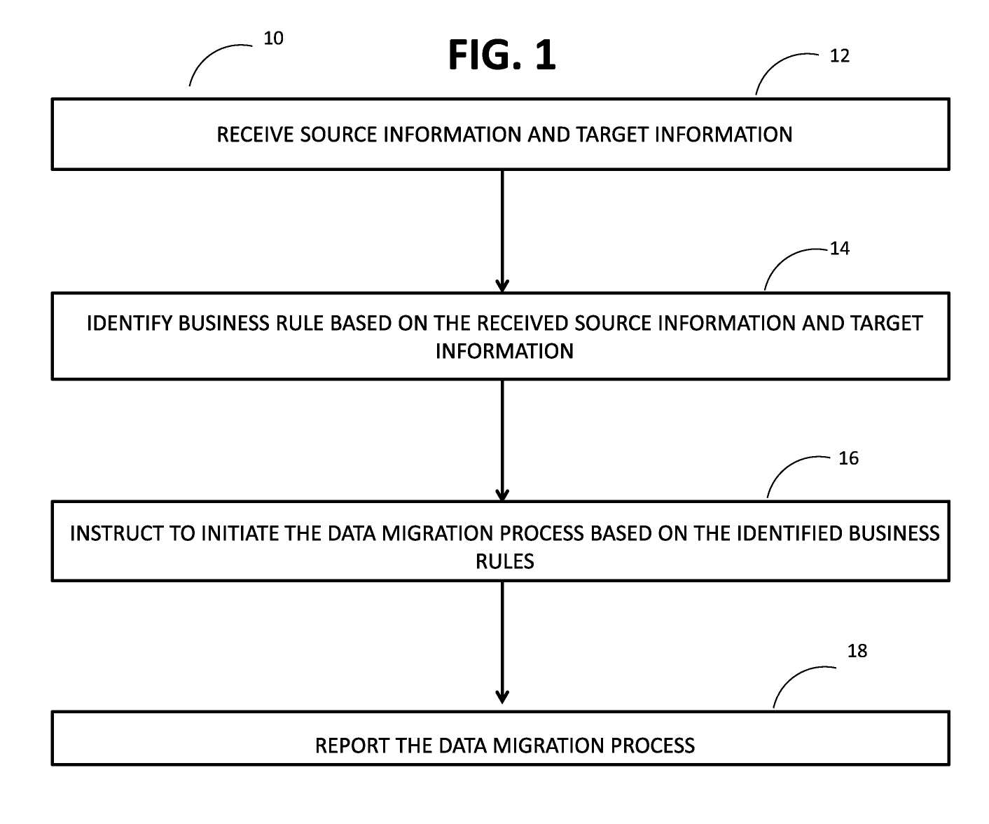

Embodiments of the present invention include a method for governance of data migration process in an enterprise from at least one source to at least one target. FIG. 1 is a flowchart representing steps involved in a method 10 for governance of data migration process in an enterprise from at least one source to at least one target. The method 10 includes receiving source information and target information using a rules engine in response to the request for data migration at step 12. In a specific embodiment, a request for data migration is made using an interactive user interface. An interactive user interface is provided for the purposes of displaying information, prompting data entry by users and receiving information. After receiving the request, the source and target are identified for receiving the source information and target information.

The method 10 also includes identifying using the rules engine at least one business rule governing the data migration process based on the received source information and the target information at step 14. The method further includes a decision step where a check is made regarding the existence of appropriate business rule in the repository. The identified business rule will be governing the data migration process. The received source information and target information at step 12 is processed further for establishing the ownership and stewardship. This received source information and target information at step 12 is also processed for profiling the data to be migrated. The received target information at step 12 is further processed for checking the readiness of the target.

The method 10 further includes instructing to initiate the data migration process by migration engine based on the identified business rule at step 16. In one embodiment the data which is to be migrated from the source to the target is extracted from source based on the identified business rule. This extracting of data correctly sets the stage for how subsequent processes go further. An intrinsic part of the extraction involves the validating of extracted data, resulting in a check if the data meets an expected pattern or structure. If not, the data may be rejected entirely or in part as per the identified business rules in this validation step. The method 10 further includes business mapping of the extracted data. The need to transfer and convert data is driven by multiple business requirements and the approach taken to the migration depends on identified business rules governing the data migration process. The method also includes transform stage which applies a series of rules or functions to the extracted data from the source to derive the data for loading into the target. Some data sources will require very little or even no manipulation of data. In other cases, one or more of the following transformation types may be required to meet the business and technical needs of the target database. This transformation is also governed based on identified business rules governing the data migration process. The load phase loads the data into the target. Depending on the requirements of the target, this process is automatically governed according to the identified business rules governing the data migration process. In an exemplary embodiment, the loading done during the process is done in stages. The method 10 further includes processing the received source information and the target information for error management in the data migration process. In a specific embodiment, the error management includes automatic error tacking in the data migration process.

The method 10 further includes reporting the data migration process completion at step 18. The user is provided with an interactive user interface for displaying information, prompting data entry and receiving information associated with the method.

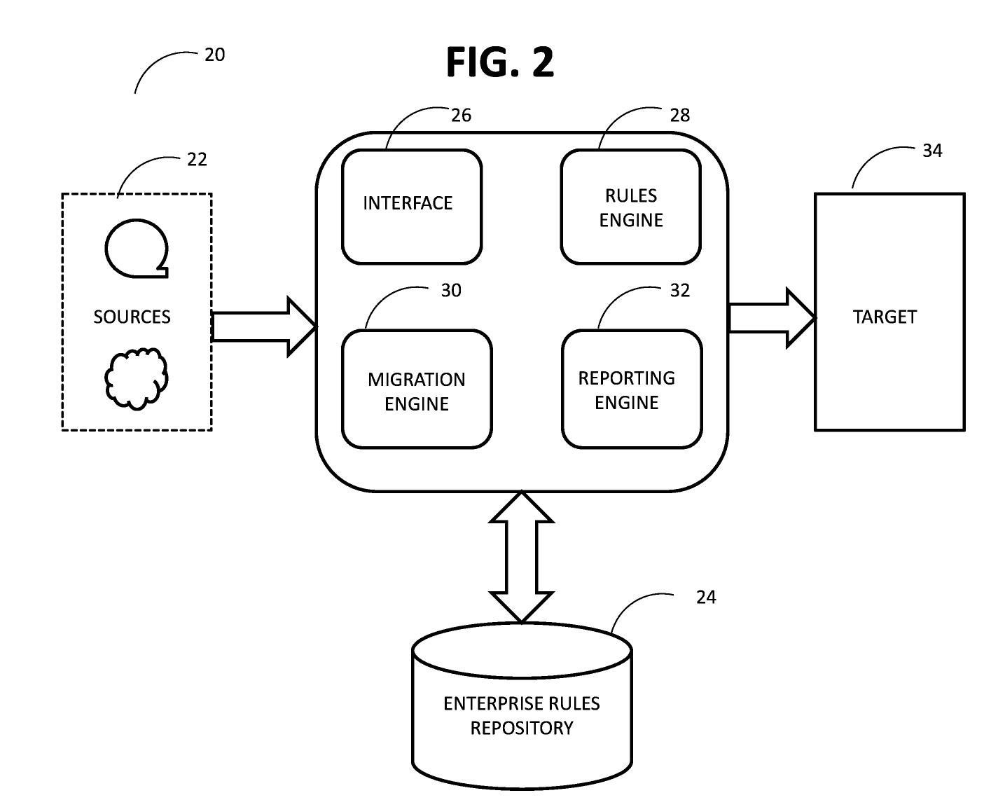

FIG. 2 is a diagrammatic representation of a system 20 for governance of data migration process in an enterprise from at least one source 22 to at least one target 34 in accordance with an embodiment of the invention. For the purposes of understanding of the invention, the source 22 and target 34 includes for all enterprise solutions, packaged application implementations, legacy re-engineering projects, application migrations from one platform to other or one database to other database, data integration scenarios, large data migrations and cloud data migrations.

The system includes an enterprise rules repository 24 which is adapted for storing and providing at least one business rule governing the data migration process. In one embodiment, the enterprise rules repository 24 provides all kinds of rules associated to business validations, data validations, and system configuration specific to target. In another embodiment, the enterprise rules repository provides rules associated with big, small, medium and applications internal to the enterprise.

The system 20 also includes a rules engine 28 which is adapted to identify at least one of the business rule governing the data migration process based on the source information and the target information. The rules engine 28 further provides a check regarding the existence of appropriate business rule in the repository. The identified business rule will be governing the data migration process. The rules engine 28 provides systematic approach for defining any rule, how it can get modified, how it can be approved and how it will make any entry into the enterprise core baseline and how those rules can be made available for the enterprise for similar kind of project deployments. Any Employee in the organization can build a business rule. A business rule will be specific to one packaged application, specific to major version. A business rule needs to be validating the data with respect to the underlying business meaning. Every Rule Entry will be sent to the approval by Subject Matter Experts, once it is identified as non-duplicate rule. Relevant SMEs check the rule entry, and either approves or rejects, based on certain published guidelines. Each approved rule will go into the enterprise rules repository baseline. Enterprise rules repository baseline will be made available for each data migration, through an automated downloading. All the activities related to rules contained in the enterprise rules repository will be through a knowledge based portal and tool, with automated workflows. The received source information and target information is processed further by the rules engine 28 for establishing the ownership and stewardship. The rules engine 28 further provides error management in the data migration process. In a specific embodiment, the error management includes automatic error tacking in the data migration process.

The system 20 further includes a migration engine 30 which is adapted to initiate the data migration process in accordance to identified business rules. In one embodiment the data which is to be migrated from the source 22 to the target 34 is extracted from source 22 based on the identified business rule by the migration engine 30. The migration engine 30 also includes capabilities for validating, business mapping, transforming and loading the extracted data to the target 34. The system 20 further includes a reporting engine 32 adapted to report the data migration process completion.

Various embodiments of the present invention provide a method and system for governance of data migration process. The method and system, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer comprises a microprocessor, which is connected to a communication bus. The computer also includes a memory, which may include a Random Access Memory (RAM) and a Read Only Memory (ROM). The computer system also comprises a storage device, which can be a hard disk drive or a removable storage drive such as a floppy disk drive, an optical disk drive, and the like. The storage device can be other similar means for loading computer programs or other instructions into the computer system.

The computer system executes a set of program instructions that are stored in one or more storage elements, to process input data. These storage elements can also hold data or other information, as desired, and may be in the form of an information source or a physical memory element present in the processing machine. Exemplary storage elements include a hard disk, a DRAM, an SRAM and an EPROM. The storage element may be external to the computer system, and connected to or inserted into the computer, to be downloaded at or prior to the time of use. Examples of such external computer program products are computer readable storage mediums such as CD-ROMS, Flash chips, floppy disks, and the like.

The set of program instructions may include various commands that instruct the processing machine to perform specific tasks, such as the steps that constitute the method of the present invention. The set of instructions may be in the form of a computer generated code or a software program. The software or computer generated code may be in various forms, such as system or application software. Further, the software or computer generated code may be in the form of a collection of separate programs, a program module with a larger program, or a portion of a program module. The software or computer generated code may also include modular programming in the form of object-oriented programming. The software program containing the set of instructions can be embedded in a computer program product, for use with a computer, the computer program product comprising a computer usable medium with a computer readable program code that is embodied therein. Processing of input data by the processing machine may be in response to users' commands, to the results of previous processing, or to a request made by another processing machine.

One or more computer-readable media (e.g., storage media) or one or more processor-readable media (e.g., storage media) can comprise computer-executable instructions causing a computing system (e.g., comprising one or more processors coupled to memory) (e.g., the computer system(s) described herein) to perform any of the methods described herein. Examples of such computer-readable or processor-readable media include magnetic media, optical media, and memory (e.g., volatile or non-volatile memory, including solid state drives or the like).

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention.

What is claimed is:

1. A method for governance of a data migration process in an enterprise from at least one source to at least one target comprising:
in response to a request for the data migration, receiving, using a rules engine, the source information and the target information;
based on the received source information and the target information, identifying, using the rules engine, at least one business rule governing the data migration process; and
based on the identified business rule, instructing to initiate the data migration process by migration engine.

2. The method as claimed in claim 1, further comprising:
processing the received source information and the target information for profiling the data to be migrated.

3. The method as claimed in claim 1, further comprising:
processing the received source information and the target information for error management in the data migration process, wherein the error management further comprises automatic error tacking in the data migration process.

4. The method as claimed in claim 1, further comprising:
providing an interactive user interface for displaying information, prompting data entry by users and receiving information associated with the method.

5. A system for governance of data migration process in an enterprise from at least one source to at least one target comprising:
one or more processors coupled to memory;
an enterprise rules repository adapted to store and provide at least one business rule;
a rules engine adapted to identify at least one of the business rules governing the data migration process based on the source information and the target information; and
a migration engine adapted to initiate the data migration process in accordance to the identified business rule.

6. The system as claimed in claim 6, further comprising:
a reporting engine adapted to report the data migration.

7. The system as claimed in claim 6, wherein the enterprise rules repository comprises rules associated with big, small, medium and applications internal to the enterprise.

8. The system as claimed in claim 6, wherein the business rule comprises business validation rules specific to the target.

9. The system as claimed in claim 6, wherein the business rules comprise data validation rules specific to the target.

10. The system as claimed in claim 6 further comprising:
an interactive user interface to display information, prompt data entry by users and to receive associated information.

11. A computer program product for use with a computer, the computer program product comprising a non-transitory computer-usable medium, the non-transitory computer usable medium including a memory and having a computer-readable program code embodied therein for checking for human interaction dynamically to enable access to a resource in a computing environment, for governance of data migration process in an enterprise from at least one source to at least one target, the computer readable program code performing the steps of:
receiving the source and the target information, in response to request for data migration;
identifying at least one business rule governing the data migration process, by the rules engine based on the received source information and the target information; and
initiating the data migration, by the data migration engine based on the identified business rules.

12. A computer program product as claimed in claim 11, wherein the steps further comprise:
processing the received source information and the target information for profiling the data to be migrated.

13. A computer program product as claimed in claim 11, wherein the steps further comprise:
processing the received source information and the target information for error management in the data migration process wherein the error management further comprises automatic error tacking in the data migration process.

14. A computer program product as claimed in claim 11, wherein the steps further comprise:
providing an interactive user interface for displaying information, prompting data entry by users and receiving associated information.
